(19) United States
(12) Patent Application Publication
(10) Pub. No.: US 2005/0051381 A1
(43) Pub. Date: Mar. 10, 2005

(54) Underbody sound damping structure for motor vehicles

(76) Inventor: Koji Imai, Kanagawa (JP)

Correspondence Address: 3M INNOVATIVE PROPERTIES COMPANY, PO BOX 33427, ST. PAUL, MN, 55133-3427, US

(21) Appl. No.: 10/496,580

(22) PCT Filed: Oct. 28, 2002
(86) PCT No.: PCT/US02/34412

(30) Foreign Application Priority Data
Dec. 4, 2001 (JP) 2001/370376

(51) Int. Cl. F16F 7/00; F16F 15/00

(52) U.S. Cl. 181/207

(57) ABSTRACT

To provide an underbody sound damping structure capable of damping stone chipping with a low cost. An underbody sound damping structure for motor vehicles, characterized by having an acryl-epoxy type heat-cured layer on the coating surface of a steel panel coated with a primer.

### FIELD OF THE INVENTION

The present invention relates to an underbody sound damping structure for motor vehicles.

### BACKGROUND OF THE INVENTION

During running of a motor vehicle, a stone or the like often collides against the underbody constituting a lower section of motor vehicle body (for example, backside of floor A, wheel house part B, sill under C, etc. as shown in FIG. 4) to generate noise of stone chipping. For protecting the underbody from both stone-chipping noise and corrosion, an undercoat is heretofore applied to the steel panel coated with a primer in the lateral or lower side of the body. In high-class cars, a resin cover is fixed but in public cars, resin cover is not used in view of the cost and an undercoat (for example, polyvinyl chloride (PVC)) is provided. In these public cars, in order to enhance the corrosion resistance and at the same time, attain sound damping with a low cost, a method of applying a thick undercoat may be employed. However, because of liquid dropping, increase in weight of vehicle, and cost therefrom the thick coating of the undercoat is limited to about 1,200 μm. To solve these problems, Japanese Unexamined Patent Publication (Kokai) No. 2-202560 suggests a protective coating for a motor vehicle body, wherein a blowing agent is added to an undercoat to make a coating film thick without causing an increase in weight. However, in this protective coating for a motor vehicle body, foamed layer sometimes becomes uneven during a vehicle production process, or foam is generated on the surface of coating. Furthermore, even if a normal pressure-sensitive adhesive tape is affixed on the primer, the adhesive layer may be disadvantageously stripped off due to the plasticizer in the undercoat.

### SUMMARY OF THE INVENTION

An object of the present invention is to provide an underbody sound damping structure capable of preventing stone-chipping noise. The present invention can provide such a structure at a low cost.

According to the present invention, an underbody sound damping structure is provided, which comprises an acryl-epoxy type heat-cured layer on the coated surface of a steel panel, such as that used in motor vehicles, coated with a primer.

By virtue of the present invention, the underbody of a motor vehicle can be made to have a sound damping ability equal to or greater than conventional resin covers and higher than that in the case of applying an undercoat directly to the steel panel. The present invention can also enable such a benefit at a low cost.

### BRIEF DESCRIPTION OF THE DRAWINGS

FIG. 1 is a cross-sectional view showing one embodiment of underbody structure of the present invention.

FIG. 2 is a schematic view showing a sound level meter.

FIG. 3 is a graph showing the results of sound level test in each Example.

FIG. 4 is a schematic view of an underbody constituting a lower section of motor vehicle body.

### DETAILED DESCRIPTION OF THE INVENTION

The underbody sound damping structure for motor vehicles according to the present invention comprises a steel panel coated with a primer, and an acryl-epoxy type cured layer. The steel panel is usually subjected to the coating of a primer by anionic or cationic electro-deposition coating. The acryl-epoxy type cured layer has corrosion protection property and also has adhesive property to intermediate coat and/or topcoat, therefore, an undercoat is not necessarily required but usually, an undercoat is applied on the cured layer.

The acryl-epoxy type cured layer is obtained by curing a pressure-sensitive adhesive film or tape containing an acryl-epoxy type curable resin. The pressure-sensitive adhesive tape or film, which can be used in the manufacture of the underbody sound damping structure of the present invention, can be thermally cured at a temperature in the baking step after the coating of undercoat or intermediate coat and/or topcoat, for example, at a temperature of 80 to 180° C. Such a film or tape is required to have resistance against chipping (stone chipping) and also against plasticizer.

The pressure-sensitive adhesive film or tape which can satisfy this requirement is a pressure-sensitive adhesive film or tape comprising an acrylic polymer, a thermosetting epoxy-containing material and a heat-curing agent for this epoxy-containing material.

The acrylic polymer is obtained by radiation-polymerizing an acryl monomer and this is a material for giving the shape of pressure-sensitive adhesive tape or film and at the same time, for imparting tackiness. In order to enable easy formation, the acrylic polymer preferably has a glass transition temperature of −25° C. to 200° C.

If such a pressure-sensitive adhesive tape or film absorbs and contains moisture, the tape or film is foamed and swelled due to increase in the volume of water in the later heating step. This may cause layer separation or floating from the steel panel or the undercoat layer. Therefore, the monomer constituting the acrylic polymer preferably has the following specific properties. The monomer suitable for the acrylic polymer comprises a radiation polymerizable acrylic monomer containing an acrylic monomer capable of exhibiting a solubility parameter of 10 to 14 (cal/cm³)^{0.5} as a homopolymer. This acrylic monomer preferably has no nitrogen atom within the molecule thereof. Here, the term “radiation” is used in a broad sense and includes energy rays such as various lights capable of triggering the polymerization of an acrylic monomer by the irradiation thereof. Specific examples thereof include ultraviolet ray and electron beam. The term “solubility parameter (SP)” as used herein can be defined by the following formula: Solubility Parameter (sp)

$$δ = {[ \frac{{\sum }_{i}^{} {e}_{i}}{{\sum }_{i}^{} {v}_{i}} ]}^{1 / 2}$$

wherein Δeᵢ is an evaporation energy of each atom or functional group constituting a homopolymer and Δvᵢ is a volume of each atom or functional group constituting the homopolymer. The definition of this solubility parameter is described in detail in Polymer Engineering and Science, Vol. 14, No. 2 (February 1974), “A Method for Estimating Both the Solubility Parameters and Molar Volumes of Liquid” by Robert F. Fedors.

The acrylic polymer is preferably contained in an amount of 40 to 250 parts by weight per 100 parts by weight of the epoxy-containing material. If the acrylic polymer content is less than about 40 parts by weight, the pressure-sensitive adhesive tape or film can hardly maintain an effective constant shape and also becomes fragile in many cases. On the other hand, if the acrylic polymer content exceeds about 250 parts by mass, the heat-cured pressure-sensitive adhesive tape or film fails in having a satisfactorily crosslinked state and is liable to exhibit low heat resistance or poor final adhesive performance.

The acrylic monomer which can show a solubility parameter of 10 to 14 (cal/cm³)^{0.5} as a homopolymer preferably occupies from 50 to 100% by weight in the entire acrylic monomer material. With an acrylic monomer content in this range, good mixing with a thermosetting epoxy-containing material can be realized and moreover, good mixing with other components for accelerating the heat curing of epoxy-containing material can be realized. Also, the acrylic monomer preferably has a solubility of 0.2% by weight or less in water at 25° C. in addition to the above-described solubility parameter of 10 to 14 cal/cm³)^{0.5}. By having such solubility in water, excellent humidity resistance can be imparted to the pressure-sensitive adhesive tape or film.

To speak specifically, suitable examples of the acrylic monomer include 2-phenoxyethyl acrylate, benzyl acrylate, phenyl acrylate, phenyl ethyl acrylate, dicyclopentenyl acrylate, dicyclopentenyloxy ethyl acrylate and tricyclo[5.2.1.0^{2,6}]decanyl (meth)acrylate. These may be used individually or in combination. Among these, the acrylic monomer is more suitably 2-phenoxyethyl acrylate, benzyl acrylate, phenyl acrylate or a combination thereof. Incidentally, these acrylic monomers are commercially available, for example, under the trade name “Biscoat #192” and “Biscoat #160” from Osaka Yuki Kagaku.

By virtue of the excellent humidity resistance attributable to the acrylic monomer used, the quality control of the pressure-sensitive adhesive tape or film is facilitated and it is not necessary to store the pressure-sensitive adhesive tape or film in a desiccator or together with a desiccant so as not expose the tape or film, for example, to dew drops in the winter season. Furthermore, even if the pressure-sensitive adhesive tape or film is left standing under high-temperature high-humidity conditions before the heat curing of epoxy-containing material, the tape or film absorbs substantially no moisture.

In the practice of the present invention, the acrylic monomer may be combined with other vinyl-base monomer, if desired, for producing the acrylic polymer. The vinyl-base monomer which can be additionally used is not particularly limited but examples thereof include (meth)acrylic acid esters having an alkyl group, represented by 2-ethylhexyl acrylate, butyl acrylate and ethyl acrylate, and also include isobornyl (meth)acrylate, glycidyl (meth)acrylate, hydroxyethyl (meth)acrylate, ethoxyethyl (meth)acrylate, (meth)acrylic acid, 2-methoxyethyl (meth)acrylate and vinyl acetate.

The acrylic monomer in general contains, as a monomer component, a monofunctional acrylic monomer having one vinyl group within one molecule but may contain a polyfunctional acrylic monomer having two or more vinyl groups within one molecule. Examples of this polyfunctional vinyl monomer include 1,4-butanediol diacrylate and 1,6-hexanediol diacrylate. Usually, the polyfunctional acrylic monomer is preferably contained in an amount of 0 to 5 parts by weight per 100 parts by weight of the acrylic monomer.

Insofar as sufficiently high humidity resistance is ensured, the acrylic monomer for the acrylic polymer constituting the pressure-sensitive adhesive tape or film may be used in combination with a nitrogen-containing vinyl-base monomer such as N,N-dimethylacrylamide, N-vinylcaprolactam, N-vinylpyrrolidone, acryloylmorpholine and acrylonitrile, so as to enhance the compatibility with an epoxy-containing material. For example, from 0 to 10 parts by weight of a nitrogen-containing vinyl-base monomer may be contained per 100 parts by weight of acrylic monomer.

The acrylic polymer is obtained by polymerizing a polymerizable monomer containing an acrylic monomer in the presence of a polymerization initiator. The polymerization initiator used here is preferably a polymerization initiator which generates free radicals upon irradiation of a radiant such as ultraviolet ray. One suitable example of the polymerization initiator is 1,2-dimethoxy-1,2-diphenylethan-1-one and this is commercially available under the trade name of “Irgacure (trademark) 651 ” from Ciba Geigy.

At the time of polymerization, a chain transfer agent may be further added in addition to the polymerization initiator so as to reduce the molecular weight of a polymer produced by the radiation polymerization of the acrylic monomer. By the addition of a chain transfer agent, the molecular weight of the acrylic polymer can be controlled and thereby suitable melting-flowing properties can be imparted to the adhesive composition. Specific examples of the chain transfer agent which can be used include halogenated hydrocarbons such as carbon tetrachloride, and sulfur compounds such as lauryl mercaptan, butyl mercaptan, ethanethiol, 2-mercapto ether and mercapto 3-propionate.

The thermosetting epoxy-containing material contained in the pressure-sensitive adhesive tape or film can contribute to the enhancement of final adhesive performance and heat resistance of the pressure-sensitive adhesive tape or film. The epoxy-containing material which can be advantageously used here is an epoxy resin having at least one oxirane ring capable of polymerizing by the ring-opening reaction. These epoxy-containing materials are called “epoxide” in a broad sense and this epoxy-containing material includes a monomer-state epoxide and a polymer-state epoxide and can be aliphatic, alicyclic or aromatic. The epoxy-containing material in general may have two epoxy groups, suitably two or more epoxy groups, on average per one molecule. These materials are particularly called polyepoxide and include epoxy-containing materials having an epoxy functionality slightly smaller than 2.0, for example, a functionality of 1.8. The average number of epoxy groups per one molecule is defined as the number obtained by dividing the number of epoxy groups in the epoxy-containing material by the total of epoxy molecules. The polymer epoxide includes a linear polymer having an epoxy group at the terminal (for example, diglycidyl ether of polyalkylene glycol) and a polymer having a unit of skeletal oxirane (for example, polybutadiene polyepoxide). The molecular weight of the epoxy-containing material may vary in the range from about 58 to 100,000. Also, if desired, a mixture of various epoxy-containing materials may be used.

In particular, examples of the thermosetting epoxy-containing material include bisphenol A type epoxy resin, bisphenol AD-type epoxy resin, bisphenol F type epoxy resin, phenol-novolak type epoxy resin, cresol-novolak type epoxy resin, alicyclic epoxy resin, triglycidyl isocyanate and heterocyclic ring-containing epoxy resins such as hydantoin epoxy; aromatic or aliphatic epoxy resins such as hydrogenated bisphenol A type epoxy resin, propylene glycol-diglycidyl ether copolymer and pentaerythritol-polyglycidyl ether copolymer; epoxy resin obtained by the reaction between alicyclic carboxylic acid and epichlorohydrin; spiro ring-containing epoxy resin; glycidyl ether type epoxy resin as a reaction product of an o(ortho)-allyl-phenol novolak compound with epichlorohydrin; and glycidyl ether type epoxy resin as a reaction product of a diallyl bisphenol compound having an allyl group at the ortho-position of respective hydroxyl groups of bisphenol A type with epichlorohydrin.

The heat-curing agent is used for heat curing the above-described thermosetting epoxy-containing material. The heat-curing agent is preferably constructed to be thermally activated and thereby cure the pressure-sensitive adhesive tape or film upon exposure to an appropriate heat source for an appropriate time period. In other words, this heat-curing agent has latent heat curability at room temperature and under heating, thermally activated for the first time to undertake the heat curing of the epoxy-containing material. Suitable examples of the heat-curing agent include, but not limited to, dicyandiamides, organic acid hydrazides, acid anhydrides, salts of Lewis acid or Broensted acid, imidazoles and tertiary amines such as urea derivatives or the like. If desired, these heat-curing agents can be combined.

More specifically, representative examples of the organic acid hydrazide used as a heat-curing agent include adipic acid dihydrazide; representative examples of the acid anhydride include phthalic anhydride, trimellitic anhydride and pyromellitic anhydride; representative examples of the salt of Lewis acid or Broensted acid include monoethylamine of boron trifluoride and piperidine of boron trifluoride; representative examples of the imidazoles include 2,4-diamino-6-[2′-methylimidazole-(1′)]-ethyl-s-triazine, 2,4-diamino-6-[2′-methylimidazole-(1′)]-ethyl-s-triazine-isocyanurate, 2-phenyl-4-benzyl-5-hydroxyethylimidazole and nickel imidazole phthalate; representative examples of the tertiary amine of urea derivative or the like include 3-phenyl-1,1-dimethylurea and 3-p-chlorophenyl-1,1-dimethylurea. Among these heat-curing agents, imidazoles and tertiary amines of urea derivatives are usually not used alone. Such a compound is used in combination with dicyandiamide, organic acid hydrazide or acid anhydride, whereby the function as an accelerator can be brought out.

The pressure-sensitive adhesive tape or film may contain, if desired, for example, a filler consisting of powder of calcium carbonate, silica, alumina, talc or the like, a microsphere filler of silica or the like, a plasticizer consisting of a phthalic acid derivative, an adipic acid derivative or a liquid rubber, an antioxidant, a surfactant, and a defoaming agent consisting of polydimethylsiloxane.

The materials for producing the pressure-sensitive adhesive tape or film may further contain a woven fabric, a non-woven fabric or the like, if desired. This fabric is impregnated into the materials before the pressure-sensitive adhesive tape or film comes to have a constant shape by the radiation polymerization of the acrylic monomer, so that the cohesive strength of the pressure-sensitive adhesive tape or film in the longitudinal and cross directions can be enhanced, the working such as slitting or stamping can be facilitated and the workability can be improved. The woven or non-woven fabric which is useful here is a fabric formed from a natural or synthetic polymer fiber such as polyester, nylon, cotton, polypropylene, cellulose acetate, acetates, a blend thereof.

As the thickness of the acryl-epoxy type heat-cured layer obtained by curing the above-described acryl-epoxy thermosetting resin is larger, the noise abating effect is higher. In order to bring out sufficiently high effect, the thickness is preferably 0.1 mm or more. However, in view of the balance with appearance and cost, the thickness of the cured layer is suitably from 0.8 to 3 mm.

Examples of the commercially available pressure-sensitive adhesive tape or film which can be used in the present invention include “Tape #9259 (trade name)” produced by Sumitomo 3M.

The underbody is preferably applied with an undercoat so as to impart corrosion protection. In the present invention, any undercoat conventionally used may be employed as the undercoat and, for example, a polyvinyl chloride, polyurethane or acryl-base undercoat may be used. However, in view of the balance between cost and performance, a vinyl chloride plastisol is generally used as the undercoat.

In one embodiment, the undercoat contains a vinyl chloride-base resin, a plasticizer, a filler, a tackifier and a pigment. For the vinyl chloride-base resin, a homopolymer of vinyl chloride or a copolymer of vinyl chloride and vinyl acetate may be used and if desired, a mixture thereof may also be used.

The plasticizer used here is DOP (dioctyl phthalate), DINP (diisononyl phthalate), DIDP (diisodecyl phthalate) or high molecular weight polyester (adipic acid-base polyester) which are usually used.

The filler may be an inorganic filler commonly used, such as calcium carbonate, talc and fused silica, however, in view of the workability on coating or the paint finishing, calcium carbonate is most frequently used. For the tackifier, a blocked isocyanate- or polyamide-base resin, an epoxy resin and a latent curing material, or a mixture thereof is used in a usual manner.

For the pigment, carbon black is used as a black pigment, titanium oxide is used as a white pigment, an azo-type, threne-type or isoindolinone-type pigment is used as a yellow pigment, and a phthalocyanine-type pigment is used as a blue pigment. In the present invention, these pigments each in a necessary amount are appropriately mixed and blended with a vinyl chloride plastisol composition composed of the above-described materials, whereby the color is controlled to approximate to the electrodeposition color.

The vinyl chloride plastisol composition essentially comprises the above-described components, however, a viscosity controlling agent or a moisture absorption stabilizer may be blended, if desired. Examples of the viscosity controlling agent include thickeners such as silicic anhydride, hydrous silicic acid, particulate calcium carbonate and bentonite. In addition, a reactive diluting material may be used in a usual manner, if desired. For the moisture absorption stabilizer, calcium oxide or the like can be used in a usual manner.

The ratio of respective components blended in the vinyl chloride plastisol composition is not particularly limited insofar as the color difference from or approximation to the electrodeposition coating is satisfied. In a representative case, the composition for use in the present invention is obtained by blending from 100 to 180 parts by weight of a plasticizer, from 160 to 180 parts by weight of filler, from 2 to 4 parts by weight of tackifier, from 2 to 10 parts by weight of pigment and from 1 to 4 parts by weight of viscosity controlling agent per 100 parts by weight of vinyl chloride resin.

However, within a range of not causing a problem in practice, the relationship in the amounts of these components blended may be varied depending on the particle size and the mixing ratio of the vinyl chloride type resin blended, the viscosity of plasticizer, and the like. Furthermore, other additives may also be added, if desired.

The thickness of the undercoat is not particularly limited but is usually from 0.1 to 1.0 mm. If the thickness is less than 0.1 mm, there may arise a problem in the corrosion protection, whereas if it exceeds 1.0 mm, liquid dropping may occur.

Production of Underbody Sound Damping Structure:

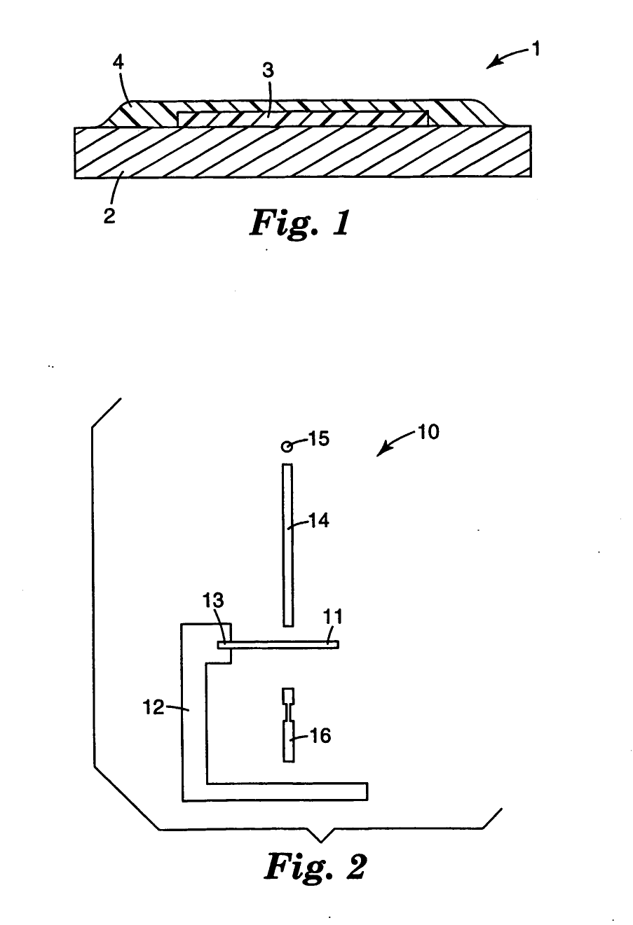

FIG. 1 is a cross-sectional view showing one embodiment of the underbody sound damping structure. The underbody sound damping structure 1 has a heat-cured resin layer 3 on a steel panel 2 coated with a primer and an undercoat layer 4 thereon. This underbody sound damping structure can be produced by a method comprising affixing an acryl-epoxy type thermosetting pressure-sensitive adhesive tape or film to a steel panel with a primer, applying an undercoat to cover the acryl-epoxy type thermosetting pressure-sensitive adhesive tape or film, thereby forming a laminate, and heating the laminate to cure the acryl-epoxy type thermosetting pressure-sensitive adhesive tape or film and at the same time, bake the undercoat. Although not shown, the underbody sound damping structure may also be produced without applying an undercoat on the upper surface of the acryl-epoxy type thermosetting pressure-sensitive adhesive tape or film.

The sill under structure where an undercoat layer is laminated is more specifically produced by the following method.

An acryl-epoxy type thermosetting pressure-sensitive adhesive tape is affixed to a steel panel with a primer at room temperature and then, an undercoat is applied thereon to obtain a laminate constituting an underbody sound damping structure precursor where an undercoat layer is provided. At this stage, the laminate is heated, for example, at a temperature of 80 to 150° C. for about 5 to 20 minutes to cure the acryl-epoxy type thermosetting pressure-sensitive adhesive film or tape and at the same time, bake the undercoat, whereby the underbody sound damping structure of the present invention is obtained. This structure is further subjected to coating of a single layer topcoat or coating of two layers of intermediate coat and topcoat. The intermediate coat and the topcoat each can be coated, for example, by applying a melamine alkyl-base coating material using electrodeposition to a thickness of 20 to 40 μm. After the coating, the intermediate coat and the topcoat each is generally baked at a temperature of 140 to 180° C. for 20 to 30 minutes. Therefore, the curing of the thermosetting pressure-sensitive adhesive film or tape and the baking of the undercoat can be performed by the baking in this coating of intermediate coat or topcoat.

### EXAMPLES

### Example 1

On an electrodeposition coated panel (hereinafter called “ED coated panel”) of 70 mm×150 mm coated with a 0.8 mm-thick primer, an acryl-epoxy tape (“Acryl Tape #9259”, trade name, produced by Sumitomo 3M, thickness: 1.0 mm) was affixed throughout one surface while leaving an exposed region over 15 mm from the edge part in the longitudinal direction. This panel was placed in an oven previously set to 140° C., left standing for 20 minutes to cure the resin, and then, allowed to cool to room temperature, thereby obtaining a laminate of ED coated panel and heat-cured resin layer for a sample of this example. This sample is a sil under as an underbody sound damping structure of the present invention.

### Comparative Example 1

The ED coated panel itself described in Example 1 was used as the sample of this Example.

### Comparative Example 2

A filler comprising 20 parts by weight of polyvinyl chloride resin for paste (“G121”, a trade name, produced by Nippon Zeon), 20 parts by weight of vinyl chloride resin for blend (“G103ZX”, trade name, produced by Nippon Zeon), 30 parts by weight of plasticizer containing di-2-ethylhexyl phthalate (“SANSONIZER DOP”, trade name, produced by Shin Nihon Rika Sha) and 45 parts by weight of calcium carbonate was mixed to prepare a vinyl chloride plastisol as a liquid undercoat composition. The obtained plastisol was applied, similarly to Example 1, throughout one surface of an ED coated panel to a thickness of 1.5 mm while leaving an exposed region over 15 mm from the edge part in the longitudinal direction. This panel was placed in an oven previously set to 140° C., left standing for 20 minutes to cure the sol, and then allowed to cool to room temperature, thereby obtaining a laminate of ED coated panel and PVC undercoat layer for a sample of this example. This sample is a conventional sill under structure.

### Comparative Example 3

A PP resin (“Side Garnish”, trade name, produced by Honda, thickness: 3.0 mm) was cut into a dimension of 70 mm×150 mm and used as the sample of this example. This sample is a sound damping resin cover generally used for the sill under of high-class cars.

Sound Level Measuring Method:

FIG. 2 is a schematic view showing a sound level measuring method 10. As shown in FIG. 2, the exposed region 13 of a sample 11 obtained in each Example was fixed to a jig 12 to stand perpendicularly to the jig. The sample of Example 1 was disposed by directing the heat-cured resin layer to face upward and the sample of Comparative Example 2 was disposed by directing the PVC undercoat layer to face upward. At the position above the intersection point on a diagonal line to the sample 11, a positioning pipe 14 was disposed to allow a hard ball 15 to fall from the height 50 cm above the sample 11 to the position. A mike 16 was disposed such that the distal end of the mike came to the position 5 cm beneath the impact location of the hard ball 15 and the mike 16 was connected to a personal computer (not shown). A ⅜ inch-diameter hard ball 15 having a weight of 3.5 g was dropped from the height of 50 cm and the sound level was measured in the compass at a measurement frequency of 500 to 8,000 Hz using a real time octave analysis software (manufactured by Ono Sokki).

Measuring Conditions:

Frequency: 500 to 8,000 Hz
Measured data: maximum value
Filter: ⅓ octave
Measuring time: 1 second

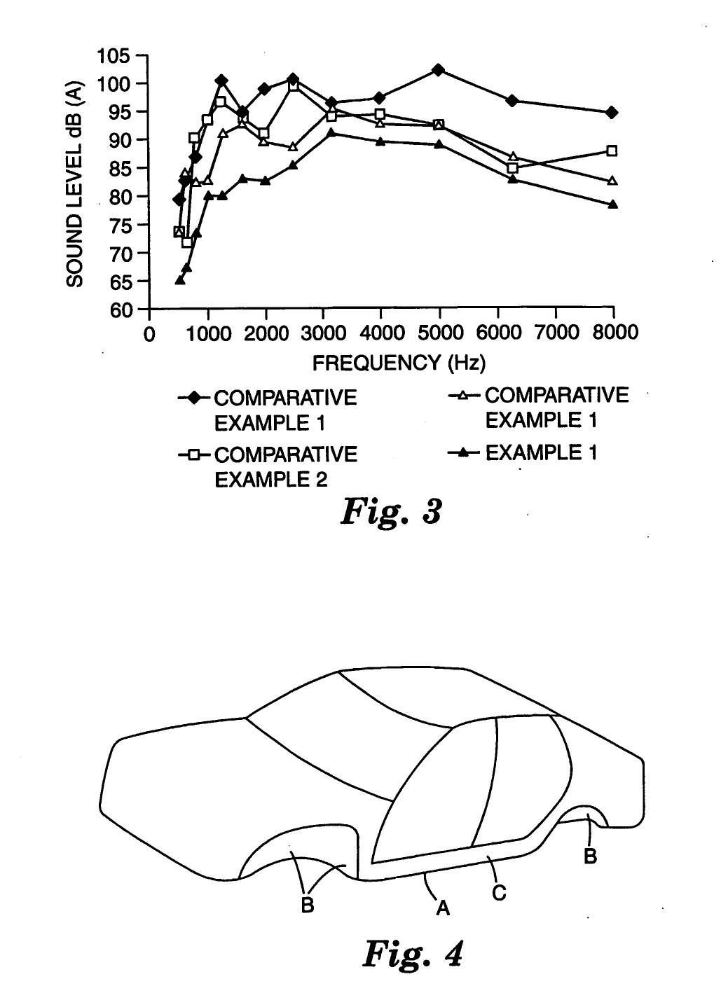

The test results obtained are shown in Table 1 below and in FIG. 3. In FIG. 3, the abscissa indicates the measurement frequency (Hz) and the ordinate indicates the sound level (dB (A)).

TABLE 1

| | dB (A) | | | |
|---|---|---|---|---|
| | | Comparative | Comparative | Comparative |
| Hz | Example 1 | Example 1 | Example 2 | Example 3 |
| 500 | 65.23 | 79.36 | 73.45 | 73.51 |
| 630 | 67.52 | 82.63 | 72.16 | 84.05 |
| 800 | 73.43 | 86.90 | 90.34 | 82.46 |
| 1000 | 80.46 | 93.89 | 93.22 | 82.92 |
| 1250 | 80.37 | 100.51 | 96.74 | 91.10 |
| 1600 | 83.20 | 94.66 | 93.31 | 92.54 |
| 2000 | 82.88 | 98.86 | 91.19 | 89.59 |
| 2500 | 85.47 | 100.68 | 99.00 | 88.57 |
| 3150 | 91.23 | 96.11 | 94.36 | 95.43 |
| 4000 | 89.16 | 97.10 | 93.85 | 92.56 |
| 5000 | 89.11 | 102.02 | 91.29 | 91.91 |
| 6300 | 82.41 | 96.31 | 83.99 | 86.45 |
| 8000 | 78.15 | 94.16 | 87.48 | 82.21 |

It is seen from the results in Table 1 and FIG. 3 that in Example 1 simulating the sill under structure of the present invention consisting of a laminate comprising acrylic-epoxy resin layer, the sound level is low at all frequencies and the result is highest. In Comparative Example 1 consisting of an ED coating panel single body, the sound level was highest in the compass of 1,000 Hz or more, revealing worst sound damping. In Comparative Example 2 simulating conventional sill under consisting of a laminate of ED coating panel and PVC undercoat, the sound level was low at a frequency of 3,000 Hz or higher but in the low frequency compass, the sound level was high. In Comparative Example 3 consisting of a resin cover used in high-class cars, the sound level was overall kept low.

The underbody sound damping structure of the present invention ensures sound damping performance equal to or greater than conventional resin cover and at the same time, higher than that in the case of applying an undercoat directly to a steel panel, with a very low cost.

1. An underbody sound damping structure for motor vehicles comprising:
a lower section of a motor vehicle body; and
a heat-curable layer on the lower section, said heat-curable layer comprising (i) an acrylic polymer formed from at least one radiation polymerizable acrylic monomer, (ii) at least one thermosettable epoxy-containing material, and (iii) a heat-curing agent.

2. An underbody sound damping structure for motor vehicles comprising an acryl-epoxy type heat-cured layer on a lower section of a motor vehicle body, said heat-cured layer having a thickness of from 0.8 to 3.0 mm.

3. The underbody sound damping structure for motor vehicles as claimed in claim 1, wherein the at least one radiation polymerizable acrylic monomer has a solubility parameter of 10 to 14 (cal/cm³)^{0.5} as a homopolymer.

4. The underbody sound damping structure for motor vehicles as claimed in claim 1, wherein the acrylic polymer is formed from 50 to 100 percent by weight of at least one radiation polymerizable acrylic monomer having a solubility parameter of 10 to 14 (cal/cm³)^{0.5} as a homopolymer based on a total amount of acrylic monomer material used to form the acrylic polymer.

5. The underbody sound damping structure for motor vehicles as claimed in claim 3, wherein the at least one radiation polymerizable acrylic monomer having a solubility parameter of 10 to 14 (cal/cm³)^{0.5} as a homopolymer comprises 2-phenoxyethyl acrylate, benzyl acrylate, phenyl acrylate, phenyl ethyl acrylate, dicyclopentenyl acrylate, dicyclopentenyloxy ethyl acrylate, tricyclo[5.2.1.0^{2,6}]decanyl (meth)acrylate, or a combination thereof.

6. The underbody sound damping structure for motor vehicles as claimed in claim 1, wherein the heat-curable layer is cured.

7. The underbody sound damping structure for motor vehicles as claimed in claim 6, wherein the thickness of said heat-cured layer is 0.1 mm or more.

8. The underbody sound damping structure for motor vehicles as claimed in claim 1, wherein said heat-curable or heat-cured layer contains from 40 to 250 parts by weight of an acryl component per 100 parts of an epoxy component.

9. The underbody sound damping structure for motor vehicles as claimed in claim 1, further comprising an undercoat layer.

10. The underbody sound damping structure for motor vehicles as claimed in claim 1, wherein the underbody sound damping structure further comprises a topcoat layer.

11. The underbody sound damping structure for motor vehicles as claimed in claim 10, wherein the underbody sound damping structure further comprises an intermediate layer between the heat-curable or heat-cured layer and the topcoat layer.

12. The underbody sound damping structure for motor vehicles as claimed in claim 1, wherein the lower section comprises a steel panel coated with a primer layer.

13. A motor vehicle having an underbody sound damping structure as claimed in claim 1.

14. A method of providing sound damping properties to a lower section of a motor vehicle, said method comprising:
applying a heat-curable sound damping structure onto the lower section of the motor vehicle, said heat-curable sound damping structure comprising a pressure-sensitive adhesive film or tape comprising an acrylic polymer, a thermosetting epoxy-containing material and a heat-curing agent.

15. The method as claimed in claim 14, wherein the sound damping structure is applied onto a steel panel coated with a primer layer.

16. The method as claimed in claim 14, further comprising:
heat curing the sound damping structure after said applying step.

17. The underbody sound damping structure for motor vehicles as claimed in claim 4, wherein the at least one radiation polymerizable acrylic monomer having a solubility parameter of 10 to 14 (cal/cm³)^{0.5} as a homopolymer comprises 2-phenoxyethyl acrylate, benzyl acrylate, phenyl acrylate, phenyl ethyl acrylate, dicyclopentenyl acrylate, dicyclopentenyloxy ethyl acrylate, tricyclo[5.2.1.0^{2,6}]decanyl (meth)acrylate, or a combination thereof.

18. The underbody sound damping structure for motor vehicles as claimed in claim 3, wherein the heat-curable layer is cured.

19. The underbody sound damping structure for motor vehicles as claimed in claim 4, wherein the heat-curable layer is cured.

20. The underbody sound damping structure for motor vehicles as claimed in claim 2, wherein said heat-curable or heat-cured layer contains from 40 to 250 parts by weight of an acryl component per 100 parts of an epoxy component.

21. The underbody sound damping structure for motor vehicles as claimed in claim 3, wherein said heat-curable or heat-cured layer contains from 40 to 250 parts by weight of an acryl component per 100 parts of an epoxy component.

22. The underbody sound damping structure for motor vehicles as claimed in claim 4, wherein said heat-curable or heat-cured layer contains from 40 to 250 parts by weight of an acryl component per 100 parts of an epoxy component.

23. The underbody sound damping structure for motor vehicles as claimed in claim 2, further comprising an undercoat layer.

24. The underbody sound damping structure for motor vehicles as claimed in claim 2, wherein the underbody sound damping structure further comprises a topcoat layer.

25. The underbody sound damping structure for motor vehicles as claimed in claim 2, wherein the lower section comprises a steel panel coated with a primer layer.

26. A motor vehicle having an underbody sound damping structure as claimed in claim 2.
